(19) United States
(12) Patent Application Publication
(10) Pub. No.: US 2023/0382776 A1
(43) Pub. Date: Nov. 30, 2023

(54) COMPOSITION, METHOD FOR PRODUCTION, AND USE OF MODIFIED GRANULAR MEDIA FOR REMOVAL OF PFAS (PER- AND POLY-FLUOROALKYL SUBSTANCES) AND THEIR WEATHERING PRODUCTS

(71) Applicant: MYCELX TECHNOLOGIES CORPORATION, Norcross, GA (US)

(72) Inventor: Hal Alper, Flowery Branch, GA (US)

(73) Assignee: MYCELX TECHNOLOGIES CORPORATION, Norcross, GA (US)

(21) Appl. No.: 18/060,711

(22) Filed: Dec. 1, 2022

Related U.S. Application Data
(60) Provisional application No. 63/365,198, filed on May 24, 2022.

(51) Int. Cl. C02F 9/00; B01J 20/20; B01J 20/04; B01J 20/28

(52) U.S. Cl. CPC C02F 9/00; B01J 20/20; B01J 20/045; B01J 20/28016; B01J 20/28004; B01J 20/2805; B01J 20/28052; C02F 2101/36

(57) ABSTRACT

This disclosure provides new filtration systems, filtration media, and processes for removing per- and polyfluoroalkyl substances (PFAS) from PFAS-contaminated water. The filtration systems, filtration media, and processes use a combination an activated carbon and a calcium sulfate which are mixed and immobilized or contained within a filter component such as a filter housing which provides a flow path for the contaminated water. This combination of components can remove PFAS contaminants to concentrations below the level of detection and provides other unexpected benefits as disclosed herein.

### CROSS-REFERENCE TO RELATED APPLICATIONS

This application claims priority from U.S. provisional patent application Ser. No. 63/365,198, filed on May 24, 2022, which is incorporated herein by reference in its entirety.

### TECHNICAL FIELD

This disclosure relates to compositions, systems, and methods for purifying water which is contaminated with per- and poly-fluoroalkyl substances (PFAS).

### BACKGROUND

Compounds known as per- and polyfluoroalkyl substances (PFAS) are synthetic organofluorine compounds containing multiple fluorine atoms bonded to an alkyl chain and which include at least one perfluroalkyl (—Cₙ—F₂ₙ—) moiety. PFAS compounds have many industrial and commercial applications as surfactants used in the manufacture of adhesives, electronic components, pharmaceuticals, AFFF (aqueous fluorinated firefighting foam), and the like and have been used for decades with little control of release to the environment. However, PFAS are bio-accumulating and toxic pollutants which are slow to decompose and difficult to remove from the environment, and which pose health and safety hazards to humans and animals.

As a result of the film forming properties of PFAS compounds and the lack of adequate regulation, PFAS are persistently present in aquifers and other natural water sources. The primary methods of PFAS removal from water currently use PFAS adsorbents or reverse osmosis (RO) membranes, both of which are problematic. Fluorinated PFAS compounds have a low affinity for hydrophobic and hydrophilic surfaces making them difficult to remove from water. Large volumes of adsorbents are required to remove small amounts of PFAS and the condition is exacerbated as the PFAS weathers, forming hydrolyzed variants which are more water soluble requiring even greater amounts of adsorbent. Membranes are easily fouled by PFAS and their film forming tendencies make crossflow difficult and inefficient. Therefore, there is a continuing need for new treatment methods and compositions which may provide improved removal of PFAS contaminants.

### SUMMARY OF THE DISCLOSURE

This disclosure provides new granular filtration media (GFM), methods for making the granular filtration media, filtration systems, and processes for purifying water which is contaminated with per- and polyfluoroalkyl substances (PFAS). Examples of per- and polyfluoroalkyl substances include perfluorosulfonic acids such as the perfluorooctanesulfonic acid (PFOS) and perfluorocarboxylic acids such as the perfluorooctanoic acid (PFOA), which are common acidic PFAS surfactants. These compounds are difficult to remove using adsorbents or reverse osmosis (RO) membranes. However, compositions and methods have been discovered which are remarkably effective for PFAS removal, in many instances, at or below the minimum detection limit.

In an aspect, the present disclosure provides methods, compositions, and systems which bypass the limitations of conventional adsorbents or membranes by employing a novel acid-base chemistry to form an insoluble calcium salt with the PFAS in combination with a novel calcium delivery method. The PFAS contaminants are acidic, and because their acidity does not diminish as weathering occurs, the methods, compositions, and systems described herein are particularly effective because their performance remains uniform across the range of PFAS compounds and their numerous hydrolyzation products. Therefore, the compositions and methods are also highly effective at removing the PFAS weathering products.

In an aspect, this disclosure provides a granular filtration media for removing PFAS from contaminated water, the media consisting essentially of: a mixture of an activated carbon and calcium sulfate. While this granular filtration media can comprise, consist essentially of, or even consist of a mixture of an activated carbon and calcium sulfate, it has been found quite unexpectedly that PFAS can be removed to concentrations below the level of detection (Practical Quantitation Limit) using only a mixture of activated carbon and calcium sulfate as described herein, without additives or further components in the filtration media. In this way, additional ingredients which would add to the expense, time, and complexity needed to prepare a highly effective filtration media can be avoided. Therefore, the granular filtration media for removing PFAS from contaminated water is described herein as a media consisting essentially of a mixture of an activated carbon and calcium sulfate.

According to another aspect, this disclosure provides a filtration system for removing PFAS from contaminated water, the system comprising: (a) a granular filtration media consisting essentially of a mixture of an activated carbon and calcium sulfate; and (b) a filter component which contains the granular filtration media and which provides a flow path for water therethrough.

An additional aspect provided by this disclosure is a method of making a granular filtration media for removing PFAS from contaminated water, the method comprising: (a) providing an amount of an activated carbon and an amount of calcium sulfate; and (b) mixing the activated carbon and the calcium sulfate in the absence of other ingredients for a time period to provide the granular filtration media.

According to a further aspect, provided herein is a process for removing PFAS from contaminated water, the process comprising: (a) providing a filtration system comprising: (i) a granular filtration media consisting essentially of a mixture of an activated carbon and calcium sulfate; and (ii) a filter component which contains the granular filtration media and which provides a flow path for water therethrough; and (b) contacting contaminated water with the granular filtration media to reduce the concentration of PFAS in the contaminated water.

These and other embodiments and aspects of the processes, methods, and compositions including catalyst compositions are described more fully in the Detailed Description and claims and further disclosure such as the Examples provided herein.

### BRIEF DESCRIPTION OF THE DRAWINGS

FIG. 1A illustrates a simplified longitudinally cross-sectioned view through a PFAS filtration system according to the disclosure, in which the granular filtration media is contained within a canister filter element which provides a flow path for the PFAS-contaminated water to provide the PFAS filtration system.

FIG. 1B a schematic transverse cross section of the FIG. 1A filter element, which contains the granular filtration media, which has been simplified by not showing the outer shell, so as to better show the flow path for the PFAS-contaminated water through the filter element.

### DETAILED DESCRIPTION

### General Description

Disclosed herein are new filtration systems, filtration media, and filtration processes for removing, that is, reducing the concentration of, per- and polyfluoroalkyl substances (PFAS) from water that is contaminated with PFAS. In an aspect, the present disclosure describes a novel acid-base chemistry which forms an insoluble calcium salt with the PFAS in combination with a novel calcium delivery method. The PFAS contaminants are acidic, and because their acidity does not diminish as weathering occurs, the methods, compositions, and systems described herein are particularly effective because their performance remains uniform across the range of PFAS compounds and their various hydrolyzation (hydrolysis) products.

In order to define more clearly the terms used herein, the following definitions and disclosure are provided.

### Definitions

To define more clearly the terms used herein, the following definitions are provided, and unless otherwise indicated or the context requires otherwise, these definitions are applicable throughout this disclosure. If a term is used in this disclosure but is not specifically defined herein, the definition from the IUPAC Compendium of Chemical Terminology, 2n d Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Regarding claim transitional terms or phrases, the transitional term “comprising”, which is synonymous with “including,” “containing,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Unless specified to the contrary, describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of, apply only to feature class to which is utilized and it is possible to have different transitional terms or phrases utilized with different features within a claim. For example a method can comprise several recited steps (and other non-recited steps) but utilize a catalyst composition preparation consisting of specific steps but utilize a catalyst composition comprising recited components and other non-recited components. While compositions and methods may be described in terms of “comprising” various components or steps, the compositions and methods can also “consist essentially of” or “consist of” the various components or steps. Similarly, while compositions and methods may be described in terms of “consisting essentially of” various components or steps, the compositions and methods can also “consist of” the various components or steps.

The terms “a,” “an,” and “the” are intended, unless specifically indicated otherwise, to include plural alternatives, e.g., at least one. For instance, the disclosure of “an organoaluminum compound” is meant to encompass one organoaluminum compound, or mixtures or combinations of more than one organoaluminum compound unless otherwise specified.

The terms “configured for use” or “adapted for use” and similar language is used herein to reflect that the particular recited structure or procedure is used in an olefin polymerization system or process. For example, unless otherwise specified, a particular structure “configured for use” means it is “configured for use in an olefin polymerization reactor system” and therefore is designed, shaped, arranged, constructed, and/or tailored to effect an olefin polymerization, as would have been understood by the skilled person.

Groups of elements of the periodic table are indicated using the numbering scheme indicated in the version of the periodic table of elements published in Chemical and Engineering News, 63(5), 27, 1985. In some instances, a group of elements may be indicated using a common name assigned to the group; for example alkali metals for Group 1 elements, alkaline earth metals for Group 2 elements, transition metals for Group 3-12 elements, and halogens or halides for Group 17 elements.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, by disclosing a temperature of from 70° C. to 80° C., Applicant's intent is to recite individually 70° C., 71° C., 72° C., 73° C., 74° C., 75° C., 76° C., 77° C., 78° C., 79° C., and 80° C., including any sub-ranges and combinations of sub-ranges encompassed therein, and these methods of describing such ranges are interchangeable. Accordingly, Applicant reserves the right to proviso out or exclude any individual members of any such group, including any sub-ranges or combinations of sub-ranges within the group, if for any reason Applicant chooses to claim less than the full measure of the disclosure.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed herein, and that each value is also herein disclosed as “about” that particular value in addition to the value itself. In aspects, “about” can be used to mean within 10% of the recited value, within 5% of the recited value, within 2% of the recited value, or within 1% of the recited value.

As used in this disclosure, the terms “granular” or “particulate” when referring to the granular or particulate filtration media and when referring to the activated carbon or calcium sulfate that may be used in making the filtration media are used interchangeably and have their ordinary and customary meaning. For example, activated carbon and calcium sulfate (CaSO₄) starting materials can be obtained from commercial sources and can be of any appropriate particle size for the selected mode of mixing the components, for example, whether by tumbling, stirring, shaking, grinding, milling, crushing, and the like, or any combination thereof, which provide the granular or particulate filtration media. In some aspects, when the activated carbon and calcium sulfate starting materials are subjected to mixing, the mixing process can result in breaking down of the particles to average sizes which are smaller than in the starting materials. For example, even when the activated carbon and calcium sulfate starting materials are mixed by tumbling, stirring, or shaking, some breaking down of the particles to average sizes which are smaller than in the starting materials can occur. The extent of particle size reduction can be controlled by how vigorous and how long the mixing method is applied. If desired, the average particle sizes of the individual starting materials can be substantially preserved or minimally reduced in the mixture with low energy, mild mixing processes imparted for shorter periods of time.

The disclosures of various publications that may be referenced throughout this specification, which are hereby incorporated by reference in pertinent part in order to more fully describe the state of the art to which the disclosed subject matter pertains. To the extent that any definition or usage provided by any document incorporated herein by reference conflicts with the definition or usage provided herein, the definition or usage provided herein controls.

Although any methods, devices, and materials similar or equivalent to those described herein can be used in the practice or testing of the invention, the typical methods, devices and materials are herein described.

For the purposes of describing and defining the present teachings, the term “substantially” is utilized to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

All publications and patents mentioned herein are incorporated herein by reference for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

These and other features, advantages and embodiments of the invention disclosed herein will be readily apparent to those exercising ordinary skill after reading the foregoing disclosures. Accordingly, while specific embodiments of the invention have been described in considerable detail, variations and modifications of those embodiments can be effected without departing from the spirit and scope of the invention as claimed.

### Filtration System, Composition, and Methods

The filtration systems, filtration media, and filtration processes for reducing the concentration of per- and polyfluoroalkyl substances (PFAS) from water employ a novel combination of granular carbon and granular calcium sulfate which has been discovered to exhibit unexpectedly improved properties for removing PFAS from PFAS-contaminated water. In an aspect, there is provided a granular filtration media (GFM) for removing PFAS from contaminated water, the media comprising, consisting essentially of, or consisting of: a mixture of an activated carbon and calcium sulfate. The mixture can be a homogeneous blend wherein the activated carbon and the calcium sulfate are uniformly distributed throughout. In another aspect, the mixture of an activated carbon and calcium sulfate can be homogeneous in color and/or homogeneous particle size to the naked human eye.

In a further aspect, this disclosure provides a filtration system for removing PFAS from contaminated water, the system comprising:
(a) a granular filtration media consisting essentially of a mixture of an activated carbon and calcium sulfate; and
(b) a filter component which contains the granular filtration media and which provides a flow path for water therethrough.

The filter component can comprise or can be selected from any type component which contains the granular filtration media and which provides a flow path for the contaminated water therethrough, such as for example a filter bed, a canister, a bag, or a tube which contains the granular filtration media.

According to another aspect, this disclosure also describes a method of making a granular filtration media for removing PFAS from contaminated water, the method comprising:
(a) providing an amount of an activated carbon and an amount of calcium sulfate; and
(b) mixing the activated carbon and the calcium sulfate in the absence of other ingredients for a time period to provide the granular filtration media.

In the method of making the granular filtration media, the activated carbon and the calcium sulfate starting materials which are mixed for a time period to provide the granular filtration media can be characterized by a variety of range of useful particle sizes. In one aspect, one efficient method of making the granular filtration media uses particle sizes of the activated carbon and the calcium sulfate which are substantially the same the particles sizes of the activated carbon and the calcium sulfate in the final mixture, which constitutes the granular filtration media. That is, in this mixing step, the average particle sizes of the individual starting materials can be preserved in the granular filtration media mixture.

According to an aspect, the calcium sulfate used herein can comprise or can be selected from anhydrous calcium sulfate. In another aspect, the calcium sulfate can comprise, consist essentially of, consist of, or can be selected from gypsum, anhydrite, or a gypsum-anhydrite blend prior to the mixing step. For example, the calcium sulfate starting material can comprise, consist essentially of, consist of, or can be selected from Drierite™, Regular Drierite™, Non-Indicating Drierite™, Commercial Drierite™, or any combination thereof. These materials are commercially available from the W A Hammond Drierite Co., Ltd., Xenia, Ohio. In an aspect, the activated carbon can comprise, consist essentially of, consist of, or can be selected from AquaCarb® Series, VOCarb® Series, AC Series, VC Series, BevCarb® Series, or UltraCarb series of activated carbons, but are not limited to any particular type of activated carbon. These materials are commercially available from Evoqua Water Technologies, Alpharetta, Georgia.

In aspects, the activated carbon and the calcium sulfate can be combined in a weight ratio of, respectively, from 90:10 to 10:90, alternatively from 80:20 to 20:80, alternatively from 70:30 to 30:70, alternatively from 60:40 to 40:60, or alternatively 50:50, in the granular filtration media. For example, the granular filtration media mixture can comprise activated carbon in a concentration of about 10 wt %, about 20 wt %, about 30 wt %, about 40 wt %, about 50 wt %, about 60 wt %, about 70 wt %, about 80 wt %, or about 90 wt % of the granular filtration media, or any range between these weight percentages, with the balance being calcium sulfate. While all of these weight percentages work in this regard, it has been discovered that: (1) from about 20 wt % to about 40 wt % calcium sulfate and from about 80 wt % to about 60 wt % activated carbon; (2) from about 25 wt % to about 35 wt % calcium sulfate and from about 75 wt % to about 65 wt % activated carbon; or (3) about 30 wt % calcium sulfate and about 70 wt % activated carbon work well. It has been found that these weight percentages of calcium sulfate being less than the weight percentage of activated carbon prevent or slow the onset of hardening of the mixture of activated carbon and calcium sulfate in the presence of water.

Alternatively, in a further aspect, the activated carbon and the calcium sulfate can be combined in a weight ratio of from about 5:1 to about 1:5, from about 3:1 to about 1:3, from about 2:1 to about 1:2, or alternatively about 1:1. For example, the carbon to calcium sulfate weight ratio in mixture can be about 5:1, about 4:1, about 3:1, about 2:1, about 1:1, about 1:2, about 1:3, about 1:4, or about 1:5, or ranges between these ratios.

In an aspect, the granular filtration media which comprises, consisting essentially of, or consists of the mixture of an activated carbon and calcium sulfate can be a homogeneous blend wherein the activated carbon and the calcium sulfate are uniformly distributed throughout. Therefore, different samples of the granular filtration media can contain the same weight ratio of activated carbon to calcium sulfate. In another aspect, the mixture of an activated carbon and calcium sulfate can be a blend which is not homogeneous and wherein the activated carbon and the calcium sulfate are not uniformly distributed throughout. However, consistently good results were obtained when the activated carbon and the calcium sulfate are uniformly distributed throughout.

According to another aspect, the mixture can be homogeneous in color or homogeneous in particle size to the naked human eye, or both. The activated carbon is typically black and the calcium sulfate is typically white or off-white in color. Regardless of the particles sizes of the activated carbon and calcium sulfate starting materials, mixing or blending can be continued until the mixture or blend appears homogeneous in color, such as when particle sizes are reduced to a sufficiently small size that the mixture or blend appears visually homogeneous. In an aspect, the visually homogeneous mixture can be light gray to dark gray, such as a charcoal gray material, depending upon the weight ratio of activated carbon to calcium sulfate.

In an aspect, for example, the activated carbon and the calcium sulfate (CaSO₄) starting materials can be obtained from commercial sources and can be of any appropriate particle size for the selected mode of mixing the components, for example, whether by tumbling, stirring, shaking, grinding, milling, crushing, and the like, or any combination thereof, which provide the granular or particulate filtration media. In embodiments the granular carbon and the granular calcium sulfate can be conveniently mixed in a cement mixer. For example, the starting materials can be granular carbon and starting granular calcium sulfate which can contain particle sizes which average about ¼-inch and smaller, although sizes of greater than ¼-inch such as about ½-inch and even larger can be used if desired, for example, when the mixing is carried out by crushing or milling. In some aspects, the starting materials can be granular carbon and starting granular calcium sulfate which can contain particle sizes of about ⅛-inch and smaller. The average particle size of the activated carbon starting material can be the same or can be different from the average particle size of the calcium sulfate starting material. In one aspect, the activated carbon starting material may be provided as 3×6 mesh, 4×6 mesh, 4×8 mesh, 4×10 mesh, 8×16 mesh, 8×20 mesh, 8×30 mesh, 12×40 mesh, or similar mesh sizes of activated carbon prior to the mixing step. In another aspect, the calcium sulfate may be provided as 4, 6, 8, or 10-20 mesh granular calcium sulfate prior to the mixing step.

The person of ordinary skill will appreciate that the average particle size of the granular filtration media, the activated carbon in the granular filtration media, and/or the calcium sulfate in the granular filtration media will affect the ability to flow contaminated water through the filtration media. The skilled person will appreciate that if the particle size is too large that insufficient contact between the PFAS in the contaminated water may occur of the flow rate is too fast, and if the particle size is too small, it may be more difficult to use flow rates that are sufficient for the process to be useful on a large scale. Although the granular filtration media is not limited to a particular particle size, the following particle sizes for granular filtration media, the activated carbon, and/or the calcium sulfate starting materials for preparing the granular filtration media, independently, have been found to be useful. Therefore, the skilled person can readily adjust the particle sizes to accommodate the necessary flow rate to accomplish the removal of at least 90% or more of the PFAS in the contaminated water.

In an aspect, the activated carbon and the calcium sulfate starting materials for preparing the granular filtration media, independently, can comprise or can be selected to contain average particle sizes of about ½-inch mesh, about 7/16 in. mesh, about ⅜ in. mesh, about 5/16 in. mesh, about 0.265 in. mesh, about No. 4 mesh, about No. 5 mesh, about No. 6 mesh, about No. 7 mesh, about No. 8 mesh, about No. 10 mesh, about No. 12 mesh, about No. 14 mesh, about No. 16 mesh, about No. 18 mesh, about No. 20 mesh, about No. 25 mesh, about No. 30 mesh, about No. 35 mesh, about No. 40 mesh, about No. 45 mesh, about No. 50 mesh, about No. 60 mesh size, or any size range between these mesh sizes.

In some aspects, when the starting carbon and calcium sulfate materials are subjected to mixing, the average particle sizes of the individual starting materials can be preserved in the mixture, or the mixing process can result in some breaking down of the particles to average sizes which are smaller than in the starting materials. For example, when the blending is particularly vigorous as it may be in a crushing process, the process itself can reduce the average the particle sizes of the starting materials to smaller sizes. Even when the blending does not appear particularly energetic such as in tumbling, the average particle sizes of the starting materials can be reduced to smaller sizes.

In some aspects, the step of mixing the activated carbon and calcium sulfate may be described as being conducted for a time period to provide the granular or particulate filtration media having a recited average particle size. This description or terminology that refers to the “time sufficient” to provide the granular filtration media is used regardless of whether or not there is any significant reduction in the average particle size of the starting materials in the final granular filtration media. Therefore, the time sufficient to provide the granular filtration media may be only as long as is needed to form the mixture or it may be longer if a specific reduction is particle size of the components is desired.

In one aspect, the granular filtration media, the activated carbon in the granular filtration media, or the calcium sulfate in the granular filtration media, independently, can have an average particle size of less than or equal to about ¼ in. mesh, less than or equal to about No. 3 ½ mesh, less than or equal to about 4 mesh, less than or equal to about 5 mesh, less than or equal to about 6 mesh, less than or equal to about 7 mesh, less than or equal to about 8 mesh, less than or equal to about 10 mesh, less than or equal to about 12 mesh, less than or equal to about 14 mesh, less than or equal to about 16 mesh, less than or equal to about 18 mesh, less than or equal to about 20 mesh, less than or equal to about 25 mesh, less than or equal to about 30 mesh, less than or equal to about 35 mesh, less than or equal to about 40 mesh, less than or equal to about No. 45 mesh, less than or equal to about No. 50 mesh, or less than or equal to about No. 60 mesh. With respect to these sizes being described as less than or equal to, suitable lower limits of these sizes can be about 40 mesh, about No. 45 mesh, about No. 50 mesh, or about No. 60 mesh. Therefore in the method for making the granular filtration media, the mixing step can be conducted for a time period to provide the granular filtration media having these average particle sizes.

According to a further aspect, the granular filtration media, the activated carbon in the granular filtration media, or the calcium sulfate in the granular filtration media, independently, can have an average particle size of about 5.0 mm, about 4.5 mm, about 4.0 mm, about 3.5 mm, about 3.0 mm, about 2.75 mm, about 2.5 mm, about 2.25 mm, about 2.0 mm, about 1.75 mm, about 1.5 mm, about 1.25 mm, about 1.0 mm, about 0.9 mm, about 0.8 mm, about 0.7 mm, about 0.6 mm, about 0.5 mm, about 0.4 mm, about 0.3 mm, about 0.2 mm, about 0.1 mm, about 0.075 mm, about 0.05 mm, about 0.025 mm, or about 0.01 mm, or any range between any of these sizes. With respect to these average particle sizes, in the method for making the granular filtration media, the mixing step can be conducted for a time period to provide the granular filtration media having these average particle sizes.

In still another aspect, the granular filtration media, the activated carbon in the granular filtration media, or the calcium sulfate in the granular filtration media, independently, can have an average particle size of from about 2.5 mm to about 0.5 mm, from about 2.0 mm to about 0.75 mm, or from about 1.75 mm to about 1.0 mm. Again, with respect to these average particle sizes, in the method for making the granular filtration media, the mixing step can be conducted for a time period to provide the granular filtration media having these average particle sizes.

This disclosure also provides for a process for removing PFAS from contaminated water, in which the process can comprise:
(a) providing a filtration system comprising:
   (i) a granular filtration media consisting essentially of a mixture of an activated carbon and calcium sulfate; and
   (ii) a filter component which contains the granular filtration media and which provides a flow path for water therethrough.
(b) contacting contaminated water with the granular filtration media to reduce the concentration of PFAS in the contaminated water.

As described herein, the filter component can comprise or can be selected from any type component which contains the granular filtration media and which provides a flow path for the contaminated water therethrough, such as for example a filter bed, a canister, a bag, or a tube which contains the granular filtration media, which provides a flow path for water therethrough, or even a combination thereof, such as a bag contained in a canister or tube.

While not intending to be bound by theory, it is believed that this system works in an unexpected fashion to provide the observed effectiveness and longevity of the filtration device and composition as follows. Although calcium sulfate (CaSO₄) is only slightly soluble, contacting calcium sulfate with water yields some calcium Ca²⁺(aq), OH⁻(aq), and [HSO₄]⁻(aq) and forms some calcium hydroxide, Ca(OH)₂. Calcium hydroxide is sparingly soluble and less soluble than calcium sulfate, so under the conditions of the granular filtration media being immobilized in the confined space of the filter bed or filter element, which limits the volume of water which can contact the filtration media, the sulfate is preferentially washed away and the calcium hydroxide is adsorbed onto the carbon. In this way, the Ca(OH)₂ hydroxyl groups are free to react and bind with the acidic moiety of the PFAS, yielding insoluble and waxy Ca-PFAS salts attached to the granular carbon. Again, while not intending to be theory bound, it is thought that the affinity of the carbon for the Ca(OH)₂ may exceed the water solubility of Ca(OH)₂, thus rendering the alkalinity permanently or irreversibly immobilized on the carbon until all of the hydroxide ion (OH⁻) is consumed by PFAS or other acidic contaminants. Thus, upon contacting PFAS-contaminated water with the granular filtration media, the PFAS can be converted to its insoluble calcium salt and immobilized on the granular carbon.

Thus, in an aspect, in the process for removing PFAS from contaminated water, upon contacting the contaminated water with the granular filtration media, the PFAS can be converted to insoluble calcium salts and immobilized on the activated carbon. In another aspect, upon contacting the contaminated water with the granular filtration media, at least 90%, at least 95%, at least 98%, at least 99%, or 100% (to below the level of detection) of the PFAS in the contaminated water can be removed. The person of ordinary skill will appreciate that the flow rate or percolation rate of the contaminated water through the granular filtration media can affect the removal efficiency of the PFAS, with too fast a flow rate not providing the necessary time for conversion of the PFAS to insoluble salts and/or adsorption or immobilization on the activated carbon. Therefore, the skilled person can readily adjust the flow rate to accomplish the removal of at least 90% or more of the PFAS in the contaminated water.

In one aspect, for example, the flow rates of the PFAS contaminated water containing the levels of PFAS as illustrated in the Examples can be from about 0.05 gallon per minute (gal/min) to about 15 gallons per minute through a filter containing the granular filtration media. In another aspect, these flow rates of the PFAS contaminated water containing the levels of PFAS as illustrated in the Examples can be about 0.05 gal/min, about 0.1 gal/min, about 0.2 gal/min, about 0.3 gal/min, about 0.4 gal/min, about 0.5 gal/min, about 0.6 gal/min, about 0.7 gal/min, about 0.8 gal/min, about 0.9 gal/min, about 1 gal/min, about 1.25 gal/min, about 1.5 gal/min, about 1.75 gal/min, about 2 gal/min, about 2.5 gal/min, about 3 gal/min, about 4 gal/min, about 5 gal/min, about 6 gal/min, about 7 gal/min, about 8 gal/min, about 9 gal/min, about 10 gal/min, about 10 gal/min, about 10 gal/min, about 10 gal/min, about 12 gal/min, or about 15 gal/min, or any ranges between any of these flow rates. For example, flow rates of the PFAS contaminated water containing the levels of PFAS as illustrated in the Examples can be 0.05-5 gal/min, 0.1-3 gal/min, or 0.2-1.5 gal/min. In embodiments, the filtration system for removing PFAS from contaminated water can include multiple filter components which contains the granular filtration media, which are configured to provide a flow path in series or in parallel. In an aspect, flow rates of 0.2-1.5 gal/min can be used in multiple units, for example, in a parallel flow path filtration system.

In typical embodiments, the granular filtration media may be contained in some type of filter component such as a filter bed or filter element or canister which contains the granular filtration media and which allows contact with water by way of some flow path. For example in an aspect, downward flow or gravity filter bed can be used or an upward flow filter bed can be used. In another aspect, the granular filtration media can be contained in a filter element. For example, filter elements which can be used can comprise or be selected from a filter bed, a canister, a bag, or a tube which contains the granular filtration media and which provides a flow path for water therethrough. Even when the filter element is simply a bag of some type, there is sufficient porosity to the bag such that water can ingress and egress and/or flow therethrough such that the PFAS-contaminated water can contact the granular filtration media. While not intending to be bound by theory, it is believed that removal of the final traces of PFAS materials using the granular filtration media is effective when the contact time between the PFAS material and the granular filtration media is sufficient, and such contact times can be readily ascertained by the skilled person.

In embodiments, the granular filtration media can be contained within a filter bed or a filter element such as a filter housing or canister, which provides a flow path for contaminated water. In an aspect, the filter bed or filter element not only immobilize the granular filtration media, but also limit the volume of water to which it can be exposed per unit time, based on flow rate. Again, while not intending to be bound by theory, it is believed that limiting the volume of water to which the granular filtration media can be exposed per unit time may be useful in allowing the chemical reactions described above to operate efficiently.

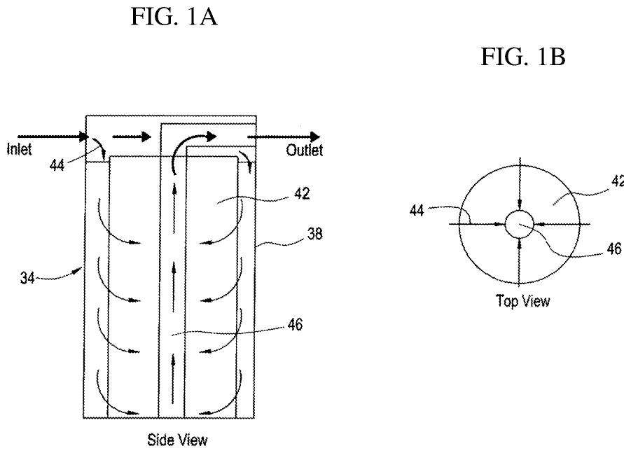

In another aspect of this disclosure, the granular filtration media can also be contained with a filter element such as illustrated in FIG. 1A and FIG. 1B. FIG. 1A shows an simplified longitudinally cross-sectioned view through an exemplary PFAS filtration system, in which the granular filtration media is contained within a canister-type filter element which provides a flow path for the PFAS-contaminated water. FIG. 1B illustrates a transverse cross section of the same FIG. 1A filter element which is simplified by not showing the outer shell, and which shows an exemplary flow path for the PFAS-contaminated water through the filter element. In these figures, filtration canister 34 contains and utilizes the granular filtration media 42 according to this disclosure, which can be immobilizes using a porous mesh, wire, fabric such as a woven or non-woven, or any material which can contain and immobilize the granular filtration media. PFAS-contaminated water flows according to flow path 44 through the canister chamber, which starts at the areas of the exposed filtration media adjacent the chamber outer wall 38 and proceeds radially inward toward the canister chamber axis 46 where the purified water is collected and then exits. This flow pattern has been found to be very effective at providing a good flow path for the contaminated water to assure effective and efficient contact between the contaminated water and the granular filtration media.

When making and using the filtration system and the granular filtration media according to the disclosed processes, the concentration of PFAS in the PFAS-contaminated water can be significantly reduced upon contacting the PFAS-contaminated water with the granular filtration media. In an aspect, for example, upon contacting PFAS-contaminated water with the granular filtration media disclosed herein, at least 95%, at least 96%, at least 97%, at least 98%, or at least 99% of the PFAS can be removed from the PFAS-contaminated water.

PFAS Filtration Train. When granular filtration media (GFM) of this disclosure is used in removing PFAS contaminants, is can be used as a “polisher” to remove some, most, or all (below the limit of detection, or the “Practical Quantitation Limit”) of the remaining low concentrations of PFAS that were not removed by the prior adsorption compositions. Therefore in an aspect, the initial filtration stages of a PFAS filtration train can include a filtration media onto or into which is infused the MYCELX® adsorption composition, and which is suitable for removing substantial concentrations of organic contaminants including PFAS. Examples of the initial filtration stages which can be used in this manner include but are not limited to the Hydrocarbon Removal Matrix® (HRM) filters and the Emulsion Breaker® (EB) filters commercially available from MyCelx Technologies Corporation. These cartridges include a substrate which is coated or infused with an absorption composition comprising a homogeneous thermal reaction product of an oil component selected from the group consisting of glycerides, fatty acids, fatty acid esters, alkenes and alkynes, and a methacrylate or acrylate polymer component. This composition is effective at reducing the high concentrations of PFAS in contaminated water to the level that the granular filtration media (GFM) of this disclosure can be used as a “polisher” to remove some, most, or all (below the Practical Quantitation Limit) of the remaining low concentrations of PFAS that were not removed by the prior adsorption compositions.

The preparation of the absorption composition which can reduce the high concentrations of PFAS in contaminated water, and the methods for coating and infusing the absorption composition are disclosed in detail in the present Applicant's U.S. Pat. Nos. 6,805,727; 6,475,393; 6,180,010; 5,437,793; 5,698,139; 5,837,146; and 5,961,823, all of the disclosures of which is incorporated herein by reference. According to one aspect, the absorption composition prepared in this manner can be viscoelastic, amphiphatic, and/or have a hydrophilic-lipophilic balance (HLB) of less than 13. Among other things, these patents disclose methods of infusing an absorption composition onto or into a filtration media which can comprise or can be selected from, for example, paper, porous ceramics, mineral particulates, or alternatively can comprise or be selected from non-woven materials such as polypropylene.

The chemistry of this absorption composition is provided by the thermal reaction product of a drying oil or oils which are caused to crosslink in the presence of oxygen or in a reducing atmosphere. Polymers such as methacrylates are also present in this crosslinking process. The resultant reaction product is a viscoelastic adsorption composition which combining with oil, various organics, and PFAS. Such reaction products are in accord with the disclosures in the previously referenced patents of the present inventor, and may also be referred to herein as MYCELX®, the registered trademark of MyCelx Technologies Corporation, the assignee of said patents, and the commercial source for the compositions.

These adsorption compositions are readily synthesized from a polymer component and an oil component selected from the group consisting of glycerides, fatty acids, fatty acid esters, alkenes and alkynes. In a preferred aspect, the product is synthesized from an isobutyl methacrylate polymer, and the oil component is one derived from a natural oil, such as linseed oil, tung oil, or sunflower oil. Optionally, the composition is then diluted with a solvent, such as 2,2,4-trimethyl-1,3-pentanediol monoisobutyrate or acetone, and the diluted composition can then be applied to at least a portion of the microporous granular substrate for use as a filtration media as disclosed herein.

The polymer component of the adsorption compositions can be a synthetic polymer such as polymers derived from methacrylates. In one aspect, the polymer is derived from methyl methacrylate, ethyl methacrylate, isobutyl methacrylate, or n-butyl methacrylate, or may be a copolymer containing a methacrylate polymer. For example, in some embodiments, the polymer is a poly(isobutyl methacrylate) polymer available under the trade name ELVACITE™ 2045, or a methacrylate/methacrylic acid copolymer such as ELVACITE™ 2008 or 2043. However, other similar polymers can be used to prepare similar compositions that can be used according to this disclosure. Combinations of polymers can be used to advantage in the preparation of the adsorption compositions.

In one embodiment of the absorption composition, the oil component of the composition can be a glyceride derived from natural oils such as oils of vegetable or animal origin. Of the vegetable oils, drying oils such as sunflower, tung, linseed, and the like; and semi-drying oils, such as soybean and cottonseed oil, have been shown to be useful as the glyceride component for use according to this disclosure. Animal oils, such as, for example, fish oil, tallow and lard can also be used as a glyceride component of the composition if desired. It is anticipated that any drying oil or semi-drying oil will work in the composition. Generally, a drying oil is defined as a spreadable liquid that will react with oxygen to form a comparatively dry film. Optionally, combinations of two or more glycerides can be used as reactants with the polymer to provide useful absorption compositions.

In an aspect, the oil component of the absorption composition can be a glyceride derived from a drying oil, such as linseed oil, that can be obtained from Cargill, Inc. as Supreme Linseed Oil, or sunflower oil. Where the oil component of the composition is a fatty acid, fatty acid esters, or alkene or alkyne utilized as the reactant with the polymer, it contains from about 8 to 24 carbon atoms, and preferably from about 10 to 22 carbon atoms. Typical fatty acids include both saturated and unsaturated fatty acids, such as lauric acid [dodecanoic acid], linolenic acid, cis-5-dodecanoic acid, oleic acid, erucic acid [cis-docosanoic acid], 10-undecynoic acid, stearic acid, caprylic acid, caproic acid, capric acid [decanoic acid], palmitic acid, docosanoic acid, myristoleic acid [cis-9-tetradecenoic acid], and linoleic acid. Combinations of fatty acids can also be used. Typical alkenes and alkynes contain at least one and preferably one or two degrees of unsaturation, and from about 8 to 24 carbon atoms, with 10-20 carbon atoms being preferred. Generally preferred alkenes and alkynes are those such as 1-decene, trans-5-decene, trans-7-tetradecene, 1,13-tetradecadiene, 1-tetradecene, 1-decyne, and 5,7-dodecadiyne.

The absorption composition is a product with characteristics different from either of the starting materials or a simple mixture of the two starting materials, thus showing that a new composition is produced by the thermal reaction. Specifically, the oil/polymer absorption compositions pass a clear pill test after being heated at the elevated temperatures and do not separate into two parts upon being cooled but, rather form a homogenous, uniphase compound.

The absorption composition is described as comprising a homogeneous thermal reaction product of an oil component selected from the group consisting of glycerides, fatty acids or their esters, alkenes and alkynes, and a methacrylate or acrylate polymer component. In some aspects, the thermal reaction product employs fatty acids and fatty acid esters as the first reactant by the direct use of a drying oil such as linseed oil or tung oil. According to another aspect, a completely different first reactant is used, in which an initial glyceride composition is provided which can comprise one or more drying oils and/or semi-drying oils, but this composition is itself not used as the first reactant to produce an absorption composition. Rather the initial glyceride composition is subjected to a cleaving and separating step to yield a blend comprising the constituent saturated and mono- and poly-unsaturated fatty acids, the fatty acid blend being unique to the initial glyceride composition. It is this unique fatty acid blend which is then thermally reacted with a methacrylate or acrylate polymer compound to yield a homogeneous thermal reaction product that constituted the absorption composition.

The preparation of the absorption composition by subjected an initial glyceride composition to a cleaving and separating step to yield a blend comprising the constituent saturated and mono- and poly-unsaturated fatty acids, is set out in detail in the present applicant's U.S. Pat. No. 9,102,549, the disclosure of which is incorporated herein by reference in its entirety. According to one aspect, the absorption composition prepared using the constituent saturated and mono- and poly-unsaturated fatty acids can be viscoelastic, amphiphatic, and/or have a hydrophilic-lipophilic balance (HLB) of less than 13.

According to an aspect of this disclosure, the initial glyceride composition that is subjected to a cleaving and separating step to yield a constituent fatty acid blend can be selected from, or can comprise, one or more drying and/or semi-drying oils from any source and having any level of processing, purification, and/or additives, including having no processing, purification and/or additives. For example, and not by way of limitation, the initial glyceride composition that is subjected to a cleaving and separating step to yield a constituent fatty acid blend can be selected from, or alternatively can comprise:
1) An “off-the-shelf” (OTS) oil, also termed a “commercial” or “purified” oil. The OTS oils typically are natural drying and/or semi-drying oils that have been processed for example by conventional washing, purification, and/or refining steps, and purified to some level to provide a commercial sample. OTS oils also generally include some type of additives such as stabilizers, antioxidants, antiskinning agents (such as methylethyl ketone oxime), rheology modifiers, and/or similar additives.
2) An “unprocessed” oil. An unprocessed oil may be referred to in the art as a “raw” oil, and typically has not been subjected to the conventional washing, purification, and/or refining steps of an OTS oil. However, some level of antioxidants or antiskinning compounds are typically included even in unprocessed oils;
3) A “natural pressed” oil. The term “natural pressed” oil is used herein to reflect a natural oil that has been directly derived from the seed by pressing, but is otherwise unprocessed before its use and absent any additives. Specifically, the natural pressed oil is used without any further purification or washing steps and without the use of any additives such as stabilizers, antioxidants, antiskinning agents (such as methylethyl ketone oxime), rheology modifiers, and the like; and/or
4) any combination thereof.
   The initial glyceride composition can be selected from, or can comprise, a drying oil, a semi-drying oil, or a combination thereof. Examples of useful oils include but are not limited to linseed oil, safflower oil, tung oil, soybean oil, menhaden oil, hemp oil, sunflower oil, rapeseed oil, and the like, including mixtures thereof.

In one aspect, natural pressed oils can be useful, for example, in providing a more tailored end product. For example, natural pressed oils can offer more controllable curing or crosslinking by allowing any additives such as curing agents or rheology modifiers to be selected and added if and when desired. The natural pressed oils also can be customized according to the particular source selection for the specific oil, such as the region, climate, or season.

### EXAMPLES

The examples of this disclosure illustrate the effectiveness of the granular filtration media (GFM) of this disclosure in removing PFAS contaminants as a polisher, which removes most or all (below the limit of detection or “Practical Quantitation Limit”) of the remaining low concentrations of PFAS that were not removed by the prior adsorption compositions, such as the MYCELX® compositions.

In the following examples and in this disclosure, the following abbreviations for per- and polyfluoroalkyl substances (PFAS) are employed.

TABLE 1
Abbreviations used in the disclosure

| | | | |
|---|---|---|---|
| PFBS | Perfluorobutanesulfonic acid | FOSA | Perfluorooctane sulfonamide |
| PFPeS | Perfluoropentanesulfonic acid | MeFOSA | N-Methyl perfluorooctane |
| | | | sulfonamide |
| PFHxS | Perfluorohexanesulfonic acid | EtFOSA | N-Ethyl perfluorooctane sulfonamide |
| PSHpS | Perfluoroheptanesulfonic acid | MeFOSE | N-Methyl perfluorooctane |
| | | | sulfonamidoethanol |
| PFOS | Perfluorooctanesulfonate | EtFOSE | N-Ethyl perfluorooctane |
| | | | sulfonamidoethanol |
| PFDS | Perfluorodecanesulfonic acid | MeFOSAA | Methyl Perfluorooctanesulfamido- |
| | | | acetic acid |
| PFBA | Perfluorobutanoic acid | EtFOSSA | Ethyl Perfluorooctanesulfamido-acetic |
| | | | acid |
| PFPeA | Perfluoropentanoic acid | 4:2 FTS | 4:2 Fluorotelomer sulfonic acid |
| PFHxA | Perfluorohexanoic acid | 6:2 FTS | 6:2 Fluorotelomer sulfonic acid |
| PFHpA | Perfluoroheptanoic acid | 8:2 FTS | 8:2 Fluorotelomer sulfonic acid |
| PFOA | Perfluorooctanoic acid | 10:2 FTS | 10:2 Fluorotelomer sulfonic acid |
| PFNA | Perfluorononanoic acid | BTEX | Total benzene, toluene, ethyl-benzene, |
| | | | and xylenes |
| PFDA | Perfluorodecanoic acid | TRH | Total recoverable hydrocarbons |
| PFUnDA | Perfluoroundecanoic acid | 4-BFB | 4-Bromofluorobenzene |
| PFDoDA | Perfluorododecanoic acid | MTBE | Methyl tertiary-butyl ether |
| PFTrDA | Perfluorotridecanoic acid | PQL | Practical Quantitation Limit |
| PFTeDA | Perfluorotetradecanoic acid | | |

### Example 1

### Preparation of the Modified Granular Media for Removal of PFAS and Their Weathering Products

The modified granular media used for the data in the Examples was prepared using 4, 6, 8, or 10-20 mesh calcium sulfate (CaSO₄) and 4×10 mesh, 8×16 mesh, 8×20 mesh, 8×30 mesh, or 12×40 mesh activated carbon, in a weight ratio of about 30 wt % calcium sulfate and about 70 wt % activated carbon. This combination was conveniently tumbled in a cement mixer until the granular filtration media mixture formed a homogeneous blend with the starting calcium sulfate and activated carbon being uniformly distributed throughout and until the mixture was homogeneous in color and consistency to the naked human eye. A filter canister having an internal volume of about 2 liters was charged with about three pounds of the granular filtration media. A filtration vessel containing several of the filter canisters in a parallel flow arrangement was employed to achieve a commercially viable throughput, with each filter canister achieving a flow rate of from about 0.25 gal/min to about 1 gal/min. Multiple filtration vessels of this arrangement were used where appropriate to attain the desired water throughput.

### Example 2

Removal of PFAS from PFAS-Contaminated Airport Storm Water Using the Modified Granular Media

Storm water runoff water from a large commercial airport was evaluated for PFAS contamination. Data from this testing is shown in Table 2, which records the PFAS concentrations in micrograms/liter (Kg/L, also parts per billion or ppb), demonstrating PFAS reduction following various filtration stages for PFAS removal from contaminated airport storm water. The PFAS concentration of the as-collected raw water, before PFAS removal treatment, is shown after an initial solids filtration step, and the reduction of PFAS is shown by the PFAS concentrations after each filtration stage. Table 2 illustrates the results after each of three filtration stages prior to the final “polisher” stage that includes the granular filtration media of this disclosure.

Each of the filtration stages represented in Table 2 are as follows. The Primary filtration stage is a combination of filters which include a filtration media onto or into which is infused the MYCELX® adsorption composition as described herein. These stages include the Hydrocarbon Removal Matrix™ (HRM™) filters and the Emulsion Breaker™ (EB™) filters commercially available from MyCelx Technologies Corporation. The Secondary filtration stage is a series of particle or sediment filters which includes both 0.5 μm (micrometer or micron) and 0.2 μm sediment or particulate filters, which are “uninfused”, that is, they do not include any MYCELX® adsorption composition. This secondary stage removes particulate contaminants prior to the tertiary filtration stage. The Tertiary filtration stage is a multi-stage MyCelx Water Soluble Organics (WSO) filter which is a pleated type filter substrate which includes the MYCELX® adsorption composition and which is designed to remove very soluble hydrocarbons including some PFAS and their weathering products.

The GFM polisher stage is the granular filtration media of this disclosure which was prepared according to Example 1. The GFM was contained in a single stage bed filter which used a slow water flow for good contact with the combination of activated carbon and calcium sulfate mixture.

TABLE 2
PFAS concentrations in micrograms/liter (μg/L), demonstrating PFAS reduction following various filtration stages
for PFAS removal from contaminated airport storm water, including the granular filtration media (GFM) polisher.

| | Pre- | Filtration Stages | | | | | | | |
|---|---|---|---|---|---|---|---|---|---|
| | filtration | Primary | Secondary | Tertiary | Granular | | | | |
| | Raw | filtration | filtration | filtration | Filtration | PFAS Reduction Primary | | PFAS Reduction Granular | |
| | inlet | stage | stage | stage | Media (GFM) | through Tertiary stages | | Filtration media stage | |
| | water | (HRM + EB) | (uninfused) | (WSO) | “Polisher” | Reduction | Reduction | Reduction | Reduction |
| | μg/L | μg/L | μg/L | μg/L | μg/L | μg/L | % | μg/L | % |
| PFBS | 33.1 | 32.7 | 35.4 | 20 | 0.002 | 13.1 | 39.6% | 19.998 | 100% |
| PFPeS | 19.4 | 18.7 | 19.5 | 11.6 | 0.002 | 7.8 | 40.2% | 11.598 | 100% |
| PFHxS | 113 | 107 | 114 | 66.1 | 0.002 | 46.9 | 41.5% | 66.098 | 100% |
| PSHpS | 105 | 69.6 | 75.2 | 18.3 | 0.002 | 86.7 | 82.6% | 18.298 | 100% |
| PFOS | 1210 | 112 | 106 | 6.96 | 0.013 | 1203.04 | 99.4% | 6.947 | 100% |
| PFDS | 1.2 | 0.144 | 0.014 | 0.002 | 0.002 | 1.198 | 99.8% | 0 | 0% |
| PFBA | 5.4 | 4.2 | 4.1 | 1.8 | 0.01 | 3.6 | 66.7% | 1.79 | 99% |
| PFPeA | 15.6 | 8.63 | 17.2 | 9.4 | 0.002 | 6.2 | 39.7% | 9.398 | 100% |
| PFHxA | 97.2 | 80 | 87.8 | 59.2 | 0.002 | 38 | 39.1% | 59.198 | 100% |
| PFHpA | 26.5 | 15.3 | 16.4 | 9 | 0.002 | 17.5 | 66.0% | 8.998 | 100% |
| PFOA | 48.5 | 21.4 | 22.5 | 12.1 | 0.002 | 36.4 | 75.1% | 12.098 | 100% |
| PFNA | 0.013 | 0.022 | 0.026 | 0.014 | 0.002 | −0.001 | −7.7% | 0.012 | 86% |
| PFDA | 0.016 | 0.004 | 0.003 | 0.002 | 0.002 | 0.014 | 87.5% | 0 | 0% |
| PFUnDA | 0.002 | 0.002 | 0.002 | 0.002 | 0.002 | 0 | 0.0% | 0 | 0% |
| PFDoDA | 0.002 | 0.002 | 0.002 | 0.002 | 0.002 | 0 | 0.0% | 0 | 0% |
| PFTrDA | 0.002 | 0.002 | 0.002 | 0.002 | 0.002 | 0 | 0.0% | 0 | 0% |
| PFTeDA | 0.005 | 0.005 | 0.005 | 0.005 | 0.005 | 0 | 0.0% | 0 | 0% |
| FOSA | 0.213 | 0.017 | 0.002 | 0.002 | 0.002 | 0.211 | 99.1% | 0 | 0% |
| MeFOSA | 0.005 | 0.005 | 0.005 | 0.005 | 0.005 | 0 | 0.0% | 0 | 0% |
| EtFOSA | 0.005 | 0.005 | 0.005 | 0.005 | 0.005 | 0 | 0.0% | 0 | 0% |
| MeFOSE | 0.005 | 0.005 | 0.005 | 0.005 | 0.005 | 0 | 0.0% | 0 | 0% |
| EtFOSE | 0.005 | 0.005 | 0.005 | 0.005 | 0.005 | 0 | 0.0% | 0 | 0% |
| MeFOSAA | 0.009 | 0.041 | 0.002 | 0.002 | 0.002 | 0.007 | 77.8% | 0 | 0% |
| EtFOSSA | 0.099 | 0.002 | 0.002 | 0.002 | 0.002 | 0.097 | 98.0% | 0 | 0% |
| 4:2 FTS | 0.005 | 0.005 | 0.005 | 0.005 | 0.005 | 0 | 0.0% | 0 | 0% |
| 6:2 FTS | 0.005 | 0.005 | 0.005 | 0.02 | 0.005 | −0.015 | −300.0% | 0.015 | 75% |
| 8:2 FTS | 0.005 | 0.005 | 0.005 | 0.016 | 0.005 | −0.011 | −220.0% | 0.011 | 69% |
| 10:2 FTS | 0.005 | 0.005 | 0.005 | 0.005 | 0.005 | 0 | 0.0% | 0 | 0% |
| Sum of | 1320 | 219 | 220 | 73.1 | 0.013 | 1246.9 | 94.5% | 73.087 | 100% |
| PFHxS and | | | | | | | | | |
| PFOS | | | | | | | | | |
| Sum of | 1680 | 470 | 498 | 214 | 0.013 | 1466 | 87.3% | 213.987 | 100% |
| PFAS | | | | | | | | | |

As illustrated in the Table 2 data, the granular filtration media (GFM) polisher of this disclosure is capable of removing 100% or nearly 100% of the PFAS remaining in the aqueous effluent from the Tertiary Stage WSO filters, that is, to or nearly to the level of detection, or below the level of detection.

### Example 3

Removal of PFAS from PFAS-Contaminated Soil and Water Samples Using the Modified Granular Media

Contaminated soil and water from a naval defense facility were evaluated for PFAS concentrations and the effectiveness of the modified granular media in reducing the PFAS concentration was examined. The PFAS concentration data from this testing is shown in Table 3, which demonstrates the performance of the modified granular media of this disclosure. The filtration stages described in Example 2 were used in the same sequence, with the results of the Primary, Secondary, and Tertiary stages combined into a single column, showing the reduction in PFAS concentrations from the raw inlet water to the effluent from the Third WSO filtration stage.

In these tests, soil samples were extracted with basified methanol. Water and soil extract were directly injected and/or concentrated after solid phase extraction (SPE), and the analysis was undertaken using LC-MS/MS methods. The PFAS data in Table 3 include the sum of branched and linear isomers where applicable. PFAS concentration results were corrected for Extracted Internal Standards (Quality Systems Manual QSM 5.3 Table B-15 terminology), which are mass labelled analytes added prior to sample preparation to assess matrix effects and verify processing of the sample. These Extracted Internal Standards are designated as Extracted ISTD samples, such as Extracted ISTD ¹³C₄ PFOS, in Table 3. PFAS analytes without a commercially available mass labelled analogue were corrected versus a closely eluting mass labelled PFAS compound.

Surrogates are also reported in the following table, which in this context are mass labelled PFAS compounds added prior to extraction but are used as monitoring compounds only, as these were not used for result correction. ENVI-carb™ or similar was used discretionally to remove interfering matrix components. Results are reported on a dry weight basis for solids and on an as-received basis for other matrices.

The Surrogate values such as Surrogate ¹³C₈ PFOS and the Extracted ISTD values such as Extracted ISTD ¹³C₄ PFOA are also measured according to LC-MS/MS methods.

TABLE 3
PFAS concentrations following various filtration stages for PFAS removal
from water and soil extract samples using the modified granular media

| | | | | Combination | Granular |
|---|---|---|---|---|---|
| | | Practical | | of Primary, | Filtration |
| | | Quantitation | Raw inlet | Secondary, | Media |
| | | Limit | water | and Tertiary | (GFM) |
| Contaminant | Units | (PQL) | (Prefiltration) | Stages | “Polisher” |
| Perfluorobutanesulfonic acid | μg/L | 0.0004 | 0.044 | 0.047 | 0.0004 |
| Perfluoropentanesulfonic acid | μg/L | 0.001 | 0.046 | 0.047 | <0.001 |
| Perfluorohexanesulfonic acid | μg/L | 0.0002 | 0.54 | 0.57 | 0.0033 |
| Perfluoroheptanesulfonic acid | μg/L | 0.001 | 0.059 | 0.050 | <0.001 |
| Perfluorooctanesulfonate PFOS | μg/L | 0.0002 | 3.8 | 4.5 | 0.0030 |
| Perfluorodecanesulfonic acid | μg/L | 0.002 | 0.01 | 0.007 | <0.002 |
| Perfluorobutanoic acid | μg/L | 0.002 | 0.046 | 0.048 | <0.002 |
| Perfluoropentanoic acid | μg/L | 0.002 | 0.061 | 0.079 | <0.002 |
| Perfluorohexanoic acid | μg/L | 0.0004 | 0.43 | 0.44 | 0.0051 |
| Perfluoroheptanoic acid | μg/L | 0.0004 | 0.034 | 0.038 | 0.0004 |
| Perfluorooctanoic acid PFOA | μg/L | 0.0002 | 0.10 | 0.10 | 0.0007 |
| Perfluorononanoic acid | μg/L | 0.001 | 0.013 | 0.013 | <0.001 |
| Perfluorodecanoic acid | μg/L | 0.002 | 0.020 | 0.021 | <0.002 |
| Perfluoroundecanoic acid | μg/L | 0.002 | <0.002 | <0.002 | <0.002 |
| Perfluorododecanoic acid | μg/L | 0.005 | <0.005 | <0.005 | <0.005 |
| Perfluorotridecanoic acid | μg/L | 0.01 | <0.01 | <0.01 | <0.01 |
| Perfluorotetradecanoic acid | μg/L | 0.05 | <0.05 | <0.05 | <0.05 |
| 4:2 FTS | μg/L | 0.001 | <0.001 | <0.001 | <0.001 |
| 6:2 FTS | μg/L | 0.0004 | 0.16 | 0.17 | 0.001 |
| 8:2 FTS | μg/L | 0.0004 | 0.12 | 0.16 | <0.0004 |
| 10:2 FTS | μg/L | 0.001 | <0.001 | <0.001 | <0.001 |
| Perfluorooctane sulfonamide | μg/L | 0.01 | 0.02 | 0.01 | <0.01 |
| N-Methyl perfluorooctane | μg/L | 0.005 | <0.005 | <0.005 | <0.005 |
| sulfonamide | | | | | |
| N-Ethyl perfluorooctanesulfon- | μg/L | 0.01 | <0.01 | <0.01 | <0.01 |
| amide | | | | | |
| N-Me perfluorooctanesulfonamido | μg/L | 0.005 | <0.005 | <0.005 | <0.005 |
| ethanol | | | | | |
| N-Et perfluorooctanesulfonamido | μg/L | 0.05 | <0.05 | <0.05 | <0.05 |
| ethanol | | | | | |
| MePerfluorooctanesulfamido acetic | μg/L | 0.002 | <0.002 | <0.002 | <0.002 |
| acid | | | | | |
| EtPerfluorooctanesulfamido acetic | μg/L | 0.002 | <0.002 | <0.002 | <0.002 |
| acid | | | | | |
| Surrogate ¹³C₈ PFOS | % | | 95 | 104 | 98 |
| Surrogate ¹³C₂ PFOA | % | | 104 | 116 | 101 |
| Extracted ISTD ¹³C₃ PFBS | % | | 113 | 113 | 126 |
| Extracted ISTD ¹⁸O₂ PFHxS | % | | 103 | 103 | 110 |
| Extracted ISTD ¹³C₄ PFOS | % | | 84 | 80 | 107 |
| Extracted ISTD ¹³C₄ PFBA | % | | 82 | 92 | 130 |
| Extracted ISTD ¹³C₃ PFPeA | % | | 81 | 78 | 142 |
| Extracted ISTD ¹³C₂ PFHxA | % | | 96 | 95 | 137 |
| Extracted ISTD ¹³C₄ PFHpA | % | | 75 | 57 | 121 |
| Extracted ISTD ¹³C₄ PFOA | % | | 96 | 82 | 133 |
| Extracted ISTD ¹³C₅ PFNA | % | | 42 | 40 | 128 |
| Extracted ISTD ¹³C₂ PFDA | % | | 141 | 144 | 123 |
| Extracted ISTD ¹³C₂ PFUnDA | % | | 108 | 123 | 92 |
| Extracted ISTD ¹³C₂ PFDoDA | % | | 96 | 88 | 88 |
| Extracted ISTD ¹³C₂ PFTeDA | % | | 57 | 70 | 46 |
| Extracted ISTD ¹³C₂ 4:2FTS | % | | # | # | # |
| Extracted ISTD ¹³C₂ 6:2FTS | % | | # | # | # |
| Extracted ISTD ¹³C₂ 8:2FTS | % | | # | # | # |
| Extracted ISTD ¹³C₈ FOSA | % | | 97 | 90 | 102 |
| Extracted ISTD d₃ N MeFOSA | % | | 39 | # | 41 |
| Extracted ISTD d₅ N EtFOSA | % | | 43 | # | 37 |
| Extracted ISTD d₇ N MeFOSE | % | | 68 | 50 | 75 |
| Extracted ISTD d₉ N EtFOSE | % | | 58 | 34 | 62 |
| Extracted ISTD d₃ N MeFOSAA | % | | 149 | 173 | 122 |
| Extracted ISTD d₅ N EtFOSAA | % | | 105 | 117 | 100 |
| Total Positive PFHxS & PFOS | μg/L | 0.0002 | 4.3 | 5.1 | 0.0063 |
| Total Positive PFOS & PFOA | μg/L | 0.0002 | 3.9 | 4.6 | 0.0037 |
| Total Positive PFAS | μg/L | 0.0002 | 5.5 | 6.3 | 0.014 |

### Example 4

Removal of PFAS from PFAS-Contaminated Water Samples Using the Modified Granular Media

Water from an industrial facility which was contaminated with PFAS was purified by passing it through the series of filtration stages described in Example 2, and these results are reported in Table 4. The PFAS concentrations after the contaminated water samples was passed through the same combination of Primary, Secondary, and Tertiary filtration stages described in Example 2 is reported, which is the same as the PFAS concentrations entering the Granular Filtration Media (GFM) stage. The PFAS concentrations in the water exiting the PFAS filtration stage is also reported, showing that most of the PFAS concentrations were below the Practical Quantitation Limit. The Surrogate samples such as Surrogate toluene-d 8

TABLE 4
PFAS concentrations of contaminated water samples entering the Granular
Filtration Media (GFM) stage (column labeled as the Combination of Primary,
Secondary, and Tertiary Stages) and after the GFM filtration stage.

| | | | Combination | Granular |
|---|---|---|---|---|
| | | | of Primary, | Filtration |
| | | | Secondary, and | Media (GFM) |
| Parameter | Units | PQL | Tertiary Stages | “Polisher” |
| Total Suspended Solids | mg/L | 5 | <5 | 500 |
| TRH C6-C9 | μg/L | 10 | 37 | <10 |
| TRH C6-C10 | μg/L | 10 | 39 | <10 |
| TRH C6-C10 less BTEX (F1) | μg/L | 10 | 39 | <10 |
| MTBE | μg/L | 1 | <1 | <1 |
| Benzene | μg/L | 1 | <1 | <1 |
| Toluene | μg/L | 1 | <1 | <1 |
| Ethylbenzene | μg/L | 1 | <1 | <1 |
| m + p-xylene | μg/L | 2 | <2 | <2 |
| o-xylene | μg/L | 1 | <1 | <1 |
| Naphthalene | μg/L | 1 | <1 | <1 |
| Surrogate | % | | 95 | 97 |
| Dibromofluoromethane | | | | |
| Surrogate toluene-d8 | % | | 99 | 94 |
| Surrogate 4-BFB | % | | 97 | 92 |
| TRH C10-C14 | μg/L | 50 | 160 | <50 |
| TRH C15-C28 | μg/L | 100 | <100 | <100 |
| TRH C29-C36 | μg/L | 100 | <100 | <100 |
| TRH > C10-C16 | μg/L | 50 | 160 | <50 |
| TRH > C10-C16 less N (F2) | μg/L | 50 | 160 | <50 |
| TRH > C16-C34 | μg/L | 100 | <100 | <100 |
| TRH > C34-C40 | μg/L | 100 | <100 | <100 |
| Surrogate o-Terphenyl | % | | 102 | 90 |
| Perfluorobutanesulfonic acid | μg/L | 0.0004 | 0.1 | <0.0004 |
| Perfluoropentanesulfonic acid | μg/L | 0.001 | 0.13 | <0.001 |
| Perfluorohexanesulfonic acid | μg/L | 0.0002 | 1.4 | <0.0002 |
| Perfluoroheptanesulfonic acid | μg/L | 0.001 | 0.11 | <0.001 |
| Perfluorooctanesulfonate PFOS | μg/L | 0.0002 | 3.1 | <0.0002 |
| Perfluorodecanesulfonic acid | μg/L | 0.002 | 0.01 | <0.002 |
| Perfluorobutanoic acid | μg/L | 0.002 | 0.051 | <0.002 |
| Perfluoropentanoic acid | μg/L | 0.002 | 0.1 | <0.002 |
| Perfluorohexanoic acid | μg/L | 0.0004 | 0.53 | <0.0004 |
| Perfluoroheptanoic acid | μg/L | 0.0004 | 0.059 | <0.0004 |
| Perfluorooctanoic acid PFOA | μg/L | 0.0002 | 0.14 | <0.0002 |
| Perfluorononanoic acid | μg/L | 0.001 | 0.013 | <0.001 |
| Perfluorodecanoic acid | μg/L | 0.002 | 0.01 | <0.002 |
| Perfluoroundecanoic acid | μg/L | 0.002 | 0.002 | <0.002 |
| Perfluorododecanoic acid | μg/L | 0.005 | <0.005 | <0.005 |
| Perfluorotridecanoic acid | μg/L | 0.01 | <0.01 | <0.01 |
| Perfluorotetradecanoic acid | μg/L | 0.05 | <0.05 | <0.05 |
| 4:2 FTS | μg/L | 0.001 | <0.001 | <0.001 |
| 6:2 FTS | μg/L | 0.0004 | 0.12 | <0.0004 |
| 8:2 FTS | μg/L | 0.0004 | 0.094 | <0.0004 |
| 10:2 FTS | μg/L | 0.001 | 0.002 | <0.001 |
| Perfluorooctane sulfonamide | μg/L | 0.01 | <0.1 | <0.01 |
| N-Methyl perfluorooctane | μg/L | 0.005 | <0.05 | <0.005 |
| sulfonamide | | | | |
| N-Ethyl perfluorooctanesulfon- | μg/L | 0.01 | <0.01 | <0.01 |
| amide | | | | |
| N-Me | μg/L | 0.005 | <0.005 | <0.005 |
| perfluorooctanesulfonamid- | | | | |
| oethanol | | | | |
| N-Et | μg/L | 0.05 | <0.05 | <0.05 |
| perfluorooctanesulfonamid- | | | | |
| oethanol | | | | |
| MePerfluorooctanesulf- amid | μg/L | 0.002 | <0.002 | <0.002 |
| oacetic acid | | | | |
| EtPerfluorooctanesulf- amid | μg/L | 0.002 | <0.002 | <0.002 |
| oacetic acid | | | | |
| Surrogate ¹³C8 PFOS | % | | 107 | 101 |
| Surrogate ¹³C2 PFOA | % | | 102 | 91 |
| Extracted ISTD ¹³C3 PFBS | % | | 82 | 110 |
| Extracted ISTD ¹⁸O2 PFHxS | % | | 109 | 110 |
| Extracted ISTD ¹³C4 PFOS | % | | 95 | 84 |
| Extracted ISTD ¹³C4 PFBA | % | | 70 | 102 |
| Extracted ISTD ¹³C3 PFPeA | % | | 60 | 97 |
| Extracted ISTD ¹³C2 PFHxA | % | | 111 | 100 |
| Extracted ISTD ¹³C4 PFHpA | % | | 102 | 102 |
| Extracted ISTD ¹³C4 PFOA | % | | 104 | 114 |
| Extracted ISTD ¹³C5 PFNA | % | | 114 | 105 |
| Extracted ISTD ¹³C2 PFDA | % | | 71 | 78 |
| Extracted ISTD ¹³C2 PFUnDA | % | | 55 | 66 |
| Extracted ISTD ¹³C2 PFDoDA | % | | 38 | 54 |
| Extracted ISTD ¹³C2 PFTeDA | % | | 46 | 70 |
| Extracted ISTD ¹³C2 4:2FTS | % | | 121 | # |
| Extracted ISTD ¹³C2 6:2FTS | % | | 141 | 168 |
| Extracted ISTD ¹³C2 8:2FTS | % | | 197 | 144 |
| Extracted ISTD ¹³C8 FOSA | % | | # | 64 |
| Extracted ISTD d3 N MeFOSA | % | | # | 43 |
| Extracted ISTD d5 N EtFOSA | % | | 35 | 40 |
| Extracted ISTD d7 N MeFOSE | % | | 25 | 49 |
| Extracted ISTD d9 N EtFOSE | % | | 33 | 53 |
| Extracted ISTD d3 N | % | | 50 | 80 |
| MeFOSAA | | | | |
| Extracted ISTD d5 N | % | | 68 | 87 |
| EtFOSAA | | | | |
| Total Positive PFHxS & PFOS | μg/L | 0.0002 | 4.5 | <0.0002 |
| Total Positive PFOS & PFOA | μg/L | 0.0002 | 3.2 | <0.0002 |
| Total Positive PFAS | μg/L | 0.0002 | 6 | <0.0002 |

### ASPECTS OF THE DISCLOSURE

The following Aspects of the Disclosure describe further features, embodiments, characteristics, and properties of the granular filtration media, the filtration system, the method of making a granular filtration media, and the process for removing PFAS from contaminated water according to this disclosure.

Aspect 1. A granular filtration media for removing PFAS from contaminated water, the media consisting essentially of:
a mixture of an activated carbon and calcium sulfate.

Aspect 2. A filtration system for removing PFAS from contaminated water, the system comprising:
(a) a granular filtration media consisting essentially of a mixture of an activated carbon and calcium sulfate; and
(b) a filter component which contains the granular filtration media and which provides a flow path for water therethrough.

Aspect 3. The filtration system for removing PFAS from contaminated water according to Aspect 2, wherein:
the filter component comprises or is selected from a filter bed, a canister, a bag, or a tube which contains the granular filtration media and which provides a flow path for water therethrough.

Aspect 4. The filtration system for removing PFAS from contaminated water according to any of Aspects 2-3, wherein:
the filtration system further comprises a filtration media infused with an absorption composition upstream of the granular filtration media in the flow path for water, wherein the absorption composition comprises a homogeneous thermal reaction product of an oil component selected from the group consisting of glycerides, fatty acids, fatty acid esters, alkenes and alkynes, and a methacrylate or acrylate polymer component.

Aspect 5. The filtration system for removing PFAS from contaminated water according to Aspect 4, wherein:
the oil component of the homogeneous thermal reaction product comprises fatty acids obtained by the process of:
(i) providing an initial glyceride composition comprising one or more drying oils and/or semi-drying oils;
(ii) cleaving and separating fatty acids from the initial glyceride composition to provide a blend comprising saturated, mono-unsaturated, and/or poly-unsaturated fatty acids, the fatty acid blend being unique to the initial glyceride composition; and
(iii) thermally reacting the fatty acid blend from step ii) with a methacrylate or acrylate polymer compound to yield a homogeneous thermal reaction product.

Aspect 6. A method of making a granular filtration media for removing PFAS from contaminated water, the method comprising:
(a) providing an amount of an activated carbon and an amount of calcium sulfate; and
(b) mixing the activated carbon and the calcium sulfate in the absence of other ingredients for a time period to provide the granular filtration media.

Aspect 7. The method of making a granular filtration media for removing PFAS from contaminated water according to Aspect 6, wherein the activated carbon and the calcium sulfate, independently, comprise or are selected to contain average particle sizes of about ½-inch mesh, about 7/16 in. mesh, about ⅜ in. mesh, about 5/16 in. mesh, about 0.265 in. mesh, about ¼ in. mesh, about No. 3 ½ mesh, about No. 4 mesh, about No. 5 mesh, about No. 6 mesh, about No. 7 mesh, about No. 8 mesh, about No. 10 mesh, about No. 12 mesh, about No. 14 mesh, about No. 16 mesh, about No. 18 mesh, about No. 20 mesh, about No. 25 mesh, about No. 30 mesh, about No. 35 mesh, about No. 40 mesh, about No. 45 mesh, about No. 50 mesh, about No. 60 mesh size, or any size range between these mesh sizes.

Aspect 8. The method of making a granular filtration media for removing PFAS from contaminated water according to Aspect 6, wherein:
the mixing step is conducted for a time period to provide the granular filtration media having an average particle size of less than or equal to about 4 mesh, less than or equal to about 5 mesh, less than or equal to about 6 mesh, less than or equal to about 7 mesh, less than or equal to about 8 mesh, less than or equal to about 10 mesh, less than or equal to about 12 mesh, less than or equal to about 14 mesh, less than or equal to about 16 mesh, less than or equal to about 18 mesh, less than or equal to about 20 mesh, less than or equal to about 25 mesh, less than or equal to about 30 mesh, less than or equal to about 35 mesh, less than or equal to about 40 mesh, less than or equal to about No. 45 mesh, less than or equal to about No. 50 mesh, or less than or equal to about No. 60 mesh.

Aspect 9. The method of making a granular filtration media for removing PFAS from contaminated water according to Aspect 6, wherein:
the mixing step is conducted for a time period to provide the granular filtration media having an average particle size of about 5.0 mm, about 4.5 mm, about 4.0 mm, about 3.5 mm, about 3.0 mm, about 2.75 mm, about 2.5 mm, about 2.25 mm, about 2.0 mm, about 1.75 mm, about 1.5 mm, about 1.25 mm, about 1.0 mm, about 0.9 mm, about 0.8 mm, about 0.7 mm, about 0.6 mm, about 0.5 mm, about 0.4 mm, about 0.3 mm, about 0.2 mm, about 0.1 mm, or any range between any of these sizes.

Aspect 10. The method of making a granular filtration media for removing PFAS from contaminated water according to Aspect 6, wherein:
the mixing step is conducted for a time period to provide the granular filtration media having an average particle size of from about 2.5 mm to about 0.5 mm, from about 2.0 mm to about 0.75 mm, or from about 1.75 mm to about 1.0 mm.

Aspect 11. The method of making a granular filtration media for removing PFAS from contaminated water according to Aspect 6, wherein:
the activated carbon is provided as 3×6 mesh, 4×6 mesh, 4×8 mesh, 4×10 mesh, 8×16 mesh, 8×20 mesh, 8×30 mesh, 12×40 mesh activated carbon prior to the mixing step.

Aspect 12. The method of making a granular filtration media for removing PFAS from contaminated water according to Aspect 6, wherein:
the calcium sulfate is provided as 4, 6, 8, or 10-20 mesh, or a combination thereof, prior to the mixing step.

Aspect 13. A process for removing PFAS from contaminated water, the process comprising:
(a) providing a filtration system comprising:
   (i) a granular filtration media consisting essentially of a mixture of an activated carbon and calcium sulfate; and
   (ii) a filter component which contains the granular filtration media and which provides a flow path for water therethrough.
(b) contacting contaminated water with the granular filtration media to reduce the concentration of PFAS in the contaminated water.

Aspect 14. The process for removing PFAS from contaminated water according to Aspect 13, wherein:
the filter component comprises or is selected from a filter bed, a canister, a bag, or a tube which contains the granular filtration media and which provides a flow path for water therethrough.

Aspect 15. The process for removing PFAS from contaminated water according to Aspect 13, wherein:
upon contacting the contaminated water with the granular filtration media, the PFAS are converted to insoluble calcium salts and immobilized on the activated carbon.

Aspect 16. The process for removing PFAS from contaminated water according to Aspect 13, wherein:
upon contacting the contaminated water with the granular filtration media, at least 90%, at least 95%, at least 98%, at least 99%, or 100% (below the Practical Quantitation Limit) of the PFAS in the contaminated water are removed.

Aspect 17. The process for removing PFAS from contaminated water according to any of Aspects 13-16, wherein:
prior to step (b) of contacting contaminated water with the granular filtration media, the contaminated water is contacted with a filtration media infused with an absorption composition comprising a homogeneous thermal reaction product of an oil component selected from the group consisting of glycerides, fatty acids, fatty acid esters, alkenes and alkynes, and a methacrylate or acrylate polymer component.

Aspect 18. The process for removing PFAS from contaminated water according to Aspect 17, wherein:
the oil component of the homogeneous thermal reaction product comprises fatty acids obtained by the process of:
(i) providing an initial glyceride composition comprising one or more drying oils and/or semi-drying oils;
(ii) cleaving and separating fatty acids from the initial glyceride composition to provide a blend comprising saturated, mono-unsaturated, and/or poly-unsaturated fatty acids, the fatty acid blend being unique to the initial glyceride composition; and
(iii) thermally reacting the fatty acid blend from step ii) with a methacrylate or acrylate polymer compound to yield a homogeneous thermal reaction product.

Aspect 19. The granular filtration media, the filtration system, the method of making a granular filtration media, or the process for removing PFAS from contaminated water according to any of the preceding Aspects, wherein:

the mixture is a homogeneous blend wherein the activated carbon and the calcium sulfate are uniformly distributed throughout.

Aspect 20. The granular filtration media, the filtration system, the method of making a granular filtration media, or the process for removing PFAS from contaminated water according to any of the preceding Aspects, wherein:

the mixture is homogeneous in color or particle size to the naked human eye.

Aspect 21. The granular filtration media, the filtration system, the method of making a granular filtration media, or the process for removing PFAS from contaminated water according to any of the preceding Aspects, wherein:

the calcium sulfate comprises or is selected from anhydrous calcium sulfate.

Aspect 22. The granular filtration media, the filtration system, the method of making a granular filtration media, or the process for removing PFAS from contaminated water according to any of the preceding Aspects, wherein:

the calcium sulfate comprises or is selected from gypsum, anhydrite, or a gypsum-anhydrite blend.

Aspect 23. The granular filtration media, the filtration system, the method of making a granular filtration media, or the process for removing PFAS from contaminated water according to any of the preceding Aspects, wherein:

the calcium sulfate comprises or is selected from Drierite™, Regular Drierite™, Non-Indicating Drierite™, Commercial Drierite™, or any combination thereof.

Aspect 24. The granular filtration media, the filtration system, the method of making a granular filtration media, or the process for removing PFAS from contaminated water according to any of the preceding Aspects, wherein:
the activated carbon comprises or is selected from AquaCarb® Series, VOCarb® Series, AC Series, VC Series, BevCarb® Series, or UltraCarb® Series activated carbon.

Aspect 25. The granular filtration media, the filtration system, the method of making a granular filtration media, or the process for removing PFAS from contaminated water according to any of the preceding Aspects, wherein:
the activated carbon and the calcium sulfate are combined in a weight ratio of, respectively, from 90:10 to 10:90, alternatively from 80:20 to 20:80, alternatively from 70:30 to 30:70, alternatively from 60:40 to 40:60, or alternatively 50:50.

Aspect 26. The granular filtration media, the filtration system, the method of making a granular filtration media, or the process for removing PFAS from contaminated water according to any of the preceding Aspects, wherein:
The mixture comprises activated carbon in a concentration of about 10 wt %, about 20 wt %, about 30 wt %, about 40 wt %, about 50 wt %, about 60 wt %, about 70 wt %, about 80 wt %, or about 90 wt %, with the balance being calcium sulfate.

Aspect 27. The granular filtration media, the filtration system, the method of making a granular filtration media, or the process for removing PFAS from contaminated water according to any of the preceding Aspects, wherein:
the activated carbon and the calcium sulfate are mixed by tumbling, stirring, shaking, grinding, milling, crushing, or any combination thereof.

Aspect 28. The granular filtration media, the filtration system, the method of making a granular filtration media, or the process for removing PFAS from contaminated water according to any of the preceding Aspects, wherein:
the granular filtration media has an average particle size of less than or equal to about 4 mesh, less than or equal to about 5 mesh, less than or equal to about 6 mesh, less than or equal to about 7 mesh, less than or equal to about 8 mesh, less than or equal to about 10 mesh, less than or equal to about 12 mesh, less than or equal to about 14 mesh, less than or equal to about 16 mesh, less than or equal to about 18 mesh, less than or equal to about 20 mesh, less than or equal to about 25 mesh, less than or equal to about 30 mesh, less than or equal to about 35 mesh, or less than or equal to about 40 mesh.

Aspect 29. The granular filtration media, the filtration system, the method of making a granular filtration media, or the process for removing PFAS from contaminated water according to any of the preceding Aspects, wherein:
the granular filtration media has an average particle size of about 5.0 mm, about 4.5 mm, about 4.0 mm, about 3.5 mm, about 3.0 mm, about 2.75 mm, about 2.5 mm, about 2.25 mm, about 2.0 mm, about 1.75 mm, about 1.5 mm, about 1.25 mm, about 1.0 mm, about 0.9 mm, about 0.8 mm, about 0.7 mm, about 0.6 mm, about 0.5 mm, about 0.4 mm, about 0.3 mm, about mm, about 0.1 mm, or any range between any of these sizes.

Aspect 30. The granular filtration media, the filtration system, the method of making a granular filtration media, or the process for removing PFAS from contaminated water according to any of the preceding Aspects, wherein:
the granular filtration media has an average particle size of from about 2.5 mm to about mm, from about 2.0 mm to about 0.75 mm, or from about 1.75 mm to about 1.0 mm.

What is claimed is:

1. A process for removing PFAS from contaminated water, the process comprising:
(a) providing a filtration system comprising:
(i) a granular filtration media consisting essentially of a mixture of an activated carbon and calcium sulfate; and
(ii) a filter component which contains the granular filtration media and which provides a flow path for water therethrough; and
(b) contacting contaminated water with the granular filtration media to reduce the concentration of PFAS in the contaminated water.

2. The process for removing PFAS from contaminated water according to claim 1, wherein the mixture is a homogeneous blend in which the activated carbon and the calcium sulfate are uniformly distributed throughout.

3. The process for removing PFAS from contaminated water according to claim 1, wherein the calcium sulfate is selected from gypsum, anhydrite, or a gypsum-anhydrite blend.

4. The process for removing PFAS from contaminated water according to claim 1, wherein the granular filtration media has an average particle size of from about 5.0 mm to about mm.

5. The process for removing PFAS from contaminated water according to claim 1, wherein the granular filtration media has an average particle size of from about 2.5 mm to about mm.

6. The process for removing PFAS from contaminated water according to claim 1, wherein the activated carbon and the calcium sulfate are combined in a weight ratio of, respectively, from 90:10 to 10:90.

7. The process for removing PFAS from contaminated water according to claim 1, wherein the activated carbon and the calcium sulfate are combined in a weight ratio of, respectively, from 70:30 to 30:70.

8. The process for removing PFAS from contaminated water according to claim 1, wherein the mixture consists essentially of from about 25 wt % to about 35 wt % calcium sulfate and from about 75 wt % to about 65 wt % activated carbon.

9. The process for removing PFAS from contaminated water according to claim 1, wherein the activated carbon and the calcium sulfate are mixed by tumbling, stirring, shaking, grinding, milling, crushing, or any combination thereof.

10. The process for removing PFAS from contaminated water according to claim 1, wherein the filter component comprises a filter bed, a canister, a bag, or a tube which contains the granular filtration media and which provides a flow path for water therethrough.

11. The process for removing PFAS from contaminated water according to claim 1, wherein upon contacting the contaminated water with the granular filtration media, the PFAS are converted to insoluble calcium salts and immobilized on the activated carbon.

12. The process for removing PFAS from contaminated water according to claim 1, wherein prior to step (b) of contacting contaminated water with the granular filtration media, the contaminated water is contacted with a filtration media infused with an absorption composition comprising a homogeneous thermal reaction product of an oil component selected from the group consisting of glycerides, fatty acids, fatty acid esters, alkenes and alkynes, and a methacrylate or acrylate polymer component.

13. The process for removing PFAS from contaminated water according to claim 12, wherein the oil component of the homogeneous thermal reaction product comprises fatty acids obtained by the process of:
(i) providing an initial glyceride composition comprising one or more drying oils and/or semi-drying oils;
(ii) cleaving and separating fatty acids from the initial glyceride composition to provide a blend comprising saturated, mono-unsaturated, and/or poly-unsaturated fatty acids, the fatty acid blend being unique to the initial glyceride composition; and
(iii) thermally reacting the fatty acid blend from step ii) with a methacrylate or acrylate polymer compound to yield a homogeneous thermal reaction product.

14. A filtration system for removing PFAS from contaminated water, the system comprising:
(a) a granular filtration media consisting essentially of a mixture of an activated carbon and calcium sulfate; and
(b) a filter component which contains the granular filtration media and which provides a flow path for water therethrough.

15. The filtration system according to claim 14, wherein the mixture is a homogeneous blend in which the activated carbon and the calcium sulfate are uniformly distributed throughout.

16. The filtration system according to claim 14, wherein the calcium sulfate is selected from gypsum, anhydrite, or a gypsum-anhydrite blend.

17. The filtration system according to claim 14, wherein the granular filtration media has an average particle size of from about 5.0 mm to about 0.05 mm.

18. The filtration system according to claim 14, wherein the activated carbon and the calcium sulfate are combined in a weight ratio of, respectively, from 90:10 to 10:90.

19. The filtration system according to claim 14, wherein the mixture consists essentially of from about 25 wt % to about 35 wt % calcium sulfate and from about 75 wt % to about 65 wt % activated carbon.

20. The filtration system according to claim 14, wherein the filter component comprises a filter bed, a canister, a bag, or a tube which contains the granular filtration media and which provides a flow path for water therethrough.

21. The filtration system according to claim 14, wherein the filtration system further comprises a filtration media infused with an absorption composition upstream of the granular filtration media in the flow path for water, wherein the absorption composition comprises a homogeneous thermal reaction product of an oil component selected from the group consisting of glycerides, fatty acids, fatty acid esters, alkenes and alkynes, and a methacrylate or acrylate polymer component.

22. The filtration system according to claim 21, wherein the oil component of the homogeneous thermal reaction product comprises fatty acids obtained by the process of:
(i) providing an initial glyceride composition comprising one or more drying oils and/or semi-drying oils;
(ii) cleaving and separating fatty acids from the initial glyceride composition to provide a blend comprising saturated, mono-unsaturated, and/or poly-unsaturated fatty acids, the fatty acid blend being unique to the initial glyceride composition; and
(iii) thermally reacting the fatty acid blend from step ii) with a methacrylate or acrylate polymer compound to yield a homogeneous thermal reaction product.

23. A granular filtration media for removing PFAS from contaminated water, the media consisting essentially of a mixture of an activated carbon and calcium sulfate.

24. The granular filtration media according to claim 23, wherein the mixture is a homogeneous blend in which the activated carbon and the calcium sulfate are uniformly distributed throughout.

25. The granular filtration media according to claim 23, wherein the mixture is homogeneous in color or particle size to the naked human eye.

26. The granular filtration media according to claim 23, wherein the calcium sulfate is selected from gypsum, anhydrite, or a gypsum-anhydrite blend.

27. The granular filtration media according to claim 23, wherein the granular filtration media has an average particle size of from about 5.0 mm to about 0.05 mm.

28. The granular filtration media according to claim 23, wherein the mixture consists essentially of from about 25 wt % to about 35 wt % calcium sulfate and from about 75 wt % to about 65 wt % activated carbon.

29. The granular filtration media according to claim 23, wherein the calcium sulfate is selected from Drierite™, Regular Drierite™, Non-Indicating Drierite™, Commercial Drierite™, or any combination thereof.

30. The granular filtration media according to claim 23, wherein the activated carbon is selected from AquaCarb® Series, VOCarb® Series, AC Series, VC Series, BevCarb® Series, or UltraCarb® Series activated carbon.
